(19) United States
(12) Patent Application Publication
(10) Pub. No.: US 2003/0131314 A1
(43) Pub. Date: Jul. 10, 2003

(54) Method of open selected files by converting paths of the files into addresses

(76) Inventors: Pin Feng Lin, Taipei (TW); Hong-Chang Wang, Taipei (TW)

Correspondence Address: PERKINS COIE LLP, PATENT-SEA, P.O. BOX 1247, SEATTLE, WA, 98111-1247, US

(21) Appl. No.: 10/039,028

(22) Filed: Jan. 4, 2002

(51) Int. Cl. G06F 15/00

(52) U.S. Cl. 715/501.1; 715/513

(57) ABSTRACT

A method for utilizing web browser to view documents comprises the following steps: the viewing area of the web browser is divided into a first display section and a second display section, wherein the first display section shows a tree diagram of the locations of file menus and individual documents, and the second display section shows the contents of a selected document. Then an accessing disk is designated to become the network disk if it is the file server on the intranet, and plural submenus, plural document names, and location paths are read from the disk. The tree structure of locations of the plural submenus and documents is formed according to the location paths of the plural submenus and documents in the disk. Next, the location paths of the plural file menus are set to become hyperlink addresses, and the tree structure of the plural submenus and documents is shown in the first display section. Since the location paths of the plural file menus being hyperlink address, when users select a document in the first display section, the web browser reveals the contents of the selected document in the second display section according to its own application programs or those supported by the system.

### FIELD OF THE INVENTION

This invention relates to methods for browsing file resources in the computer. More particularly, this invention relates to a method that convert the paths of document into addresses in order to employ the web browser to call associated application programs to open selected files.

### BACKGROUND

With the development of computers as well as the progress of hardware such as CPU and memory, computer processing is much faster than that in the past. It is the support of operation system and of web browser in software and the development of broadband network that datum searching, web browsing, and file downloading are no longer required so much time or take a lot of patient but feed little back. Even watching real time videos through Internet and carrying distant education and videoconference out have already not been difficult any more.

All these make the network more close to our daily life, and especially the high-speed of information communication has change the geographic effect on us. If tracking their catalysis and acceleration, the source may be the appearance of WWW (world wide web). WWW contains all the web pages using HTML (hypertext markup language) format. HTML is a standard of format for constructing web pages. Before that, the protocol and syntax previous used cannot display such a complicated web pages in the way of windows with images and animations. In addition, the web browsers supporting to this syntax are Navigator Browser developed by Netscape Communication and then Internet Explorer developed by Microsoft, and these are most common now.

HTML is a simple and verbalized language and establishes a formatted language, which can display document on browsers, by using the serialized tag. It reveals the contents by employing browser to open the window. Moreover, in order to increase the interaction of web pages, the VBScript and JavaScript are developed by researchers. After that, Microsoft applied a U.S. Pat. No. 6,101,510, which relates to computer software for browsing computer networks such as the Internet or an intranet, in order to protect its application to web browsers. The address, namely the position, of a web page or a website should be known before the browser open them. This address has a standard format, and URL, Uniform Resource Locator, is used to distribute the Internet address of the file in the server. Besides, the address usually contains the protocol, server name, structure of directories, and file name. The protocol is the standard of data communication between computers, and because of the variety of data exist different protocols. It can be believed that more development and application in Internet would come with the novel technology and various demands. Moreover, establishing a transnational corporation would be much easier by utilizing these Internet technologies.

As described, it has become the mainstream to program by using ASP, namely Active Server Pages, and HTML as well as its extension, such as VBScript and JavaScript. The web pages made in this way would be very gorgeous and splendid, but also time-consuming. As far as an enterprise is concerned, the swift update and uploading of information are the key points instead of the superficially clever web pages. However, with the conventional technique, it still requires much time and task to define an address for each of the ample data and upload them to servers, even without the demand for web pages design. In addition to other multifarious arguments setting, it is surely inefficient and laborious. Hence, the technique to convert file data into links between web pages automatically is certainly in need. In this way, the resource sharing within the enterprise would be more economical. Moreover, the enterprise could gain favor from the progress of Internet and promote the competitiveness as well.

### SUMMARY

The object of the present invention is mainly to provide a method to view content of documents directly on the network by revealing the content in the similarly form of web page.

The further object of the present invention is to generate links between server end and user end automatically by the program or the system instead of by the programmer when a user uploads some ordinary data to the server. This way would be conducive to the resource sharing on the Internet.

A method for utilizing web browser to view documents comprises the following steps: the viewing area of the web browser is divided into a first display section and a second display section, wherein the first display section shows a tree diagram of the locations of file menus and individual documents, and the second display section shows the contents of a selected document. Then an accessing disk is designated to become the network disk if it is the file server on the intranet, and plural submenus, plural document names, and location paths are read from the disk. The tree structure of locations of the plural submenus and documents is formed according to the location paths of the plural submenus and documents in the disk. Next, the location paths of the plural file menus are set to become hyperlink addresses, and the tree structure of the plural submenus and documents is shown in the first display section. Since the location paths of the plural file menus being hyperlink address, when users select a document in the first display section, the web browser reveals the contents of the selected document in the second display section according to its own application programs or those supported by the system.

### BRIEF DESCRIPTION OF THE DRAWING

FIG. 1 is a diagrammatic illustration of viewing area.

FIG. 2 is an initial flow diagram.

FIG. 3 is an initial flow diagram showing steps in a method for selecting a menu.

FIG. 4 is a flow diagram showing steps in a method for selecting a node.

FIG. 5 is a flow diagram showing steps after selecting a file.

FIG. 6 is a flow diagram of the entirety procedures.

FIG. 7(a), FIG. 7(b), FIG. 7(c), and FIG. 7(d) is a diagrammatic illustration of the viewing areas of exemplary programs.

### DETAILED DESCRIPTION

This invention mainly provides a method to view content of documents directly on the network by revealing the content in similar form of web pages. Users can easily open various documents with different formats and view the content of them by employing the web browser or with the support of the application programs installed in the system. Since the documents are displayed in similar form of web pages, the file management would not worry about any modification of the documents. Typically, the location of a file in which disk is presented by so call path indication. Through the method for this invention, the position of documents, namely the path indication, is transformed into the address form. Hence, when users find the document out, it can be opened by the web browser. The detailed description of this invention is as follows:

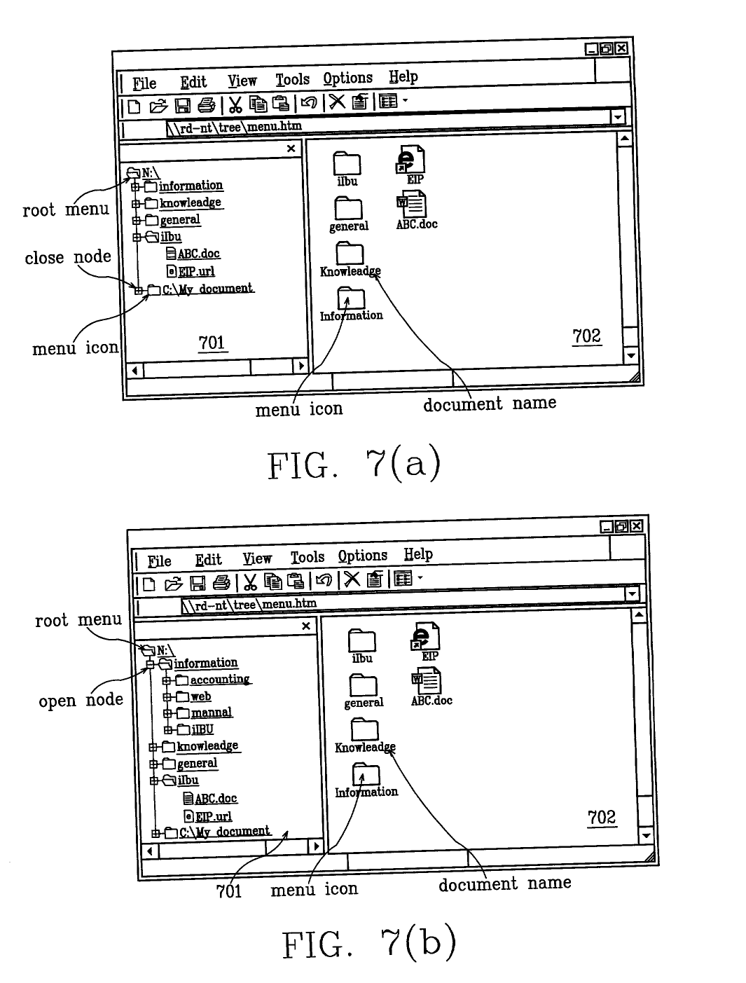

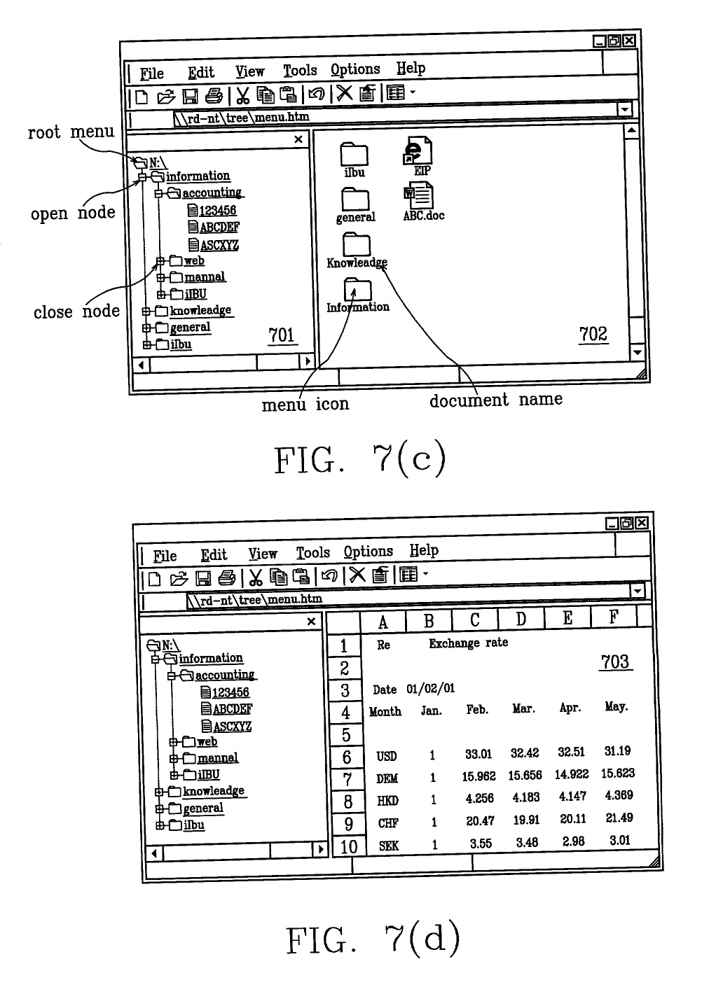

First, this invention utilizes the browser to open any file, so a web browser has to be provided. The common used browsers include IE developed by Microsoft, Netscape Navigator by Netscape, and Mosaic by NCSA as well as University of Illinois. The detailed illustrations of this invention, FIG. 7(a), FIG. 7(b), FIG. 7(c), and FIG. 7(d), use IE as the preferred example, but it only illustrates the present invention rather than limiting of the present invention. A person skilled in the art would alter proper web browsers to fit different type of computer, such as Mac, or operation system, such as Linux. Because of this invention, the users on the intranet can browse data by the browser on PC and open the documents at once, viewing the content of them. Merely the addresses instead of content of documents can be found in traditional way via File Manager. To view the content, associated programs of individual documents should be executed. In addition, this process will repeat if searching some files. It has been certainly time-consuming to execute single application program only, if there are plural kinds of application, it will consume a great deal of system resource as well. This invention is able to reveal the content of documents of various formats.

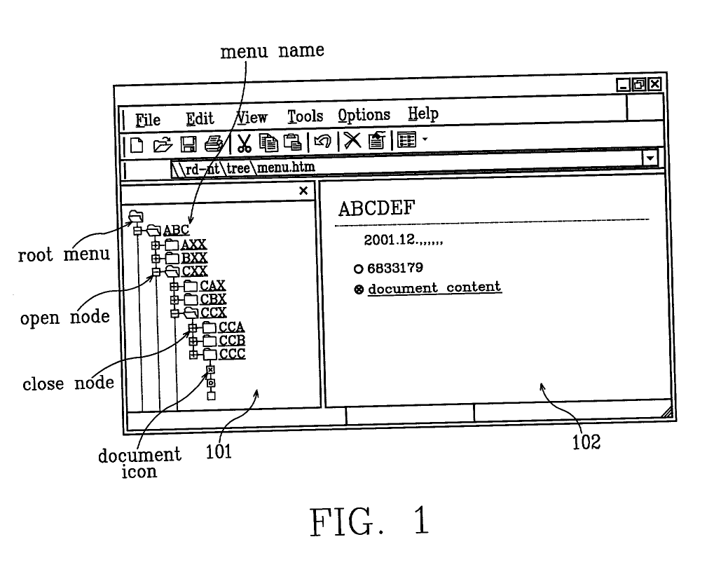

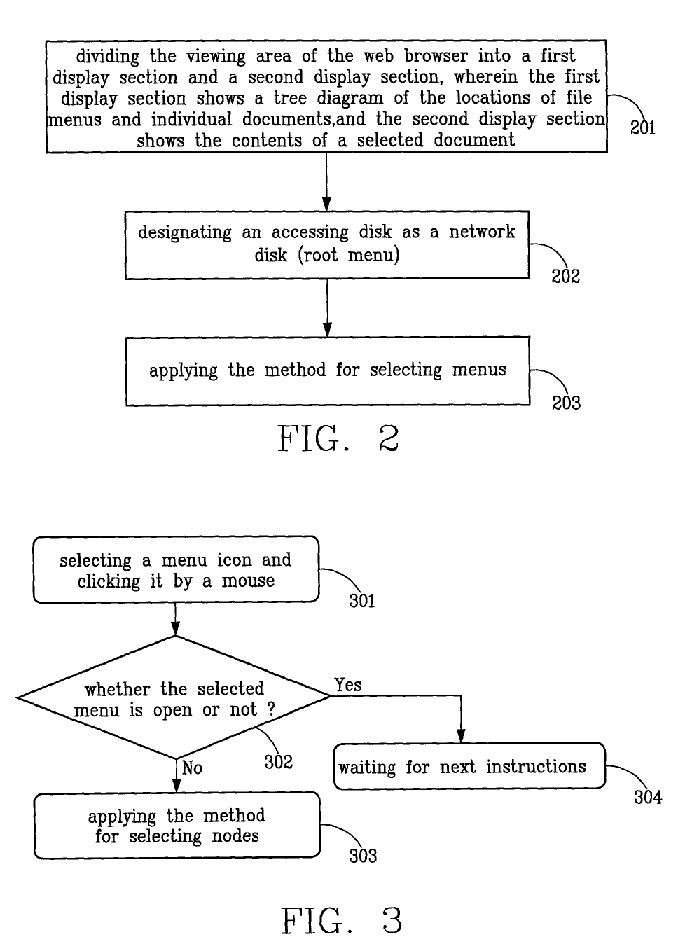

FIG. 2 shows the flow diagram illustrating how can this invention operate. First, in order to open documents by using web browser and make it convenient for users to search documents, the function of file management is added into this invention. As depicted in step 201 in FIG. 2, the viewing area is divided into two separation areas. The first display section is designated to display the tree structure of file menus, and the second display section is designated to reveal the content of selected menu or document. As shown in FIG. 1, the first display section 101 shows the tree structure of file menus, and the second display section 102 reveals the content of the selected file. The exhibited file is a text document with an extended name, txt. It is noted that the opening documents are not confined to text documents but also comprises documents with formats like xls (Excel document), mdb (Access document), doc (Word document), ppt (PowerPoint document), txt (text document), rtf (text document), wri (text document), pdf (E-book), htm (web page), html (web page), eml (E-mail), url (website address), asp (web page), ordinary picture document (such as jpg, gif, bmp, etc.), and etc. Moreover, they are opened by application program invoked by the browser. If a menu is selected, the second display section 702 reveals its menu or document. Of course, if there is nothing in the menu, the second display section will be blank.

As shown in step 202, a root menu is in need since the method for this invention is utilizing web browser to open documents. For example, any accessing disk can be selected and designated as a network disk if it is a file server on the intranet, and appointed as a root menu. Then, the relative information of the menus and the documents in the root menu is read, and by this information, the tree structure of the document menu is generated, as shown in first display section 101 in FIG. 1.

This invention provides a method for selecting menus in order to exhibit and search the relative information of documents and then generate the tree structure of document menus. This process is depicted in FIG. 3. First, initial instructions are input by a user. The initial instructions usually represent the selecting action in general, namely the command that users select some menu, such as moving the cursor to point out some menu icon and clicking it by a mouse. In this way, the initial instructions are recognized via the computer and the operation system, and following actions will be taken to the selected menu. In this preferred example, after a disk is defined, that is completing the setting of a root menu, the method for selecting menus will be executed without waiting for the action of choosing, for this root menu (disk) has been designated as a menu to be browsed. On the other hand, it is noted that this method for selecting menus can repeat to apply whenever any menu is selected (an action of choosing) by a user.

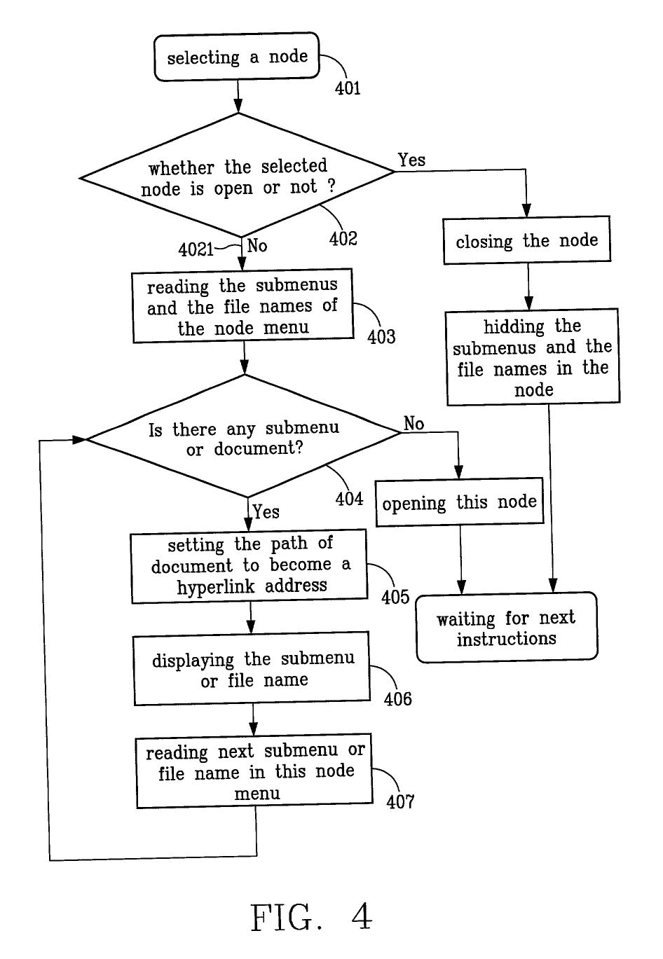

Sequentially, the method for selecting will detect whether the selected menu is open or not. If it is, the situation will become the waiting status for next instructions by users. Otherwise, the node of this selected menu will be further handled. As far as the disposition of this node is concerned, inclusive of obtaining the information of the submenu and the document in the selected menu, this invention provides a method for selecting nodes included in that for selecting menus. Hence, the process would get into the method for selecting nodes if the selected menu is not open yet, as shown in FIG. 3, and the step 303 in FIG. 2 will continue to step 401 in FIG. 4.

As shown in FIG. 4, the method for selecting nodes is to be applied. First, the node, i.e. the selected menu node, is detected whether open or not. Although this method for selecting nodes is a part of that for selecting menus, it still possesses complete functions, operating independently when accepting instructions by users. That is, this method for selecting nodes would be initiated when a user selects some node. Therefore, if this node is detected as an open one, the method for selecting node will close it and hide the submenus as well as the file names in it because the selecting by users is usually viewed as the attempt to change the status (open the closed and close the open), as shown in line 4022 in FIG. 4. Then the next instructions by users are waited.

If the node is detected as a closed one, as shown in line 4021 in FIG. 4, the submenus and the file names of the node menu are read sequentially. If there is not any submenu or document in it, the node will be opened and next instructions will be waited as well. The submenu will be revealed if it does exist, and then, a submenu or a file name is read. The path of document will be set to become a hyperlink address if the document does exist, and then, the file name will be displayed, and next submenu or file name in this node menu will be read as well. This loop is executed repeatedly until the result of menu detection becomes empty. After jumping out of this loop, this node is opened and next instructions by users are waited for. The path of document is set to become a hyperlink address. To cite a preferred instance, N:\directoryA\directoryA1\document.txt (That means document.txt is placed in the submenu directoryA1 of menu directoryA in disk N) will be designated as a hyperlink address, file:///N:\directoryA\directoryA1\document.txt.

If the method for selecting nodes is applied via that for selecting menus, the selected menu must have been recognized as a closed one, and detection of the node results in a closed status as well. Hence, the following steps after the node being recognized as a closed one as recited are going to be executed.

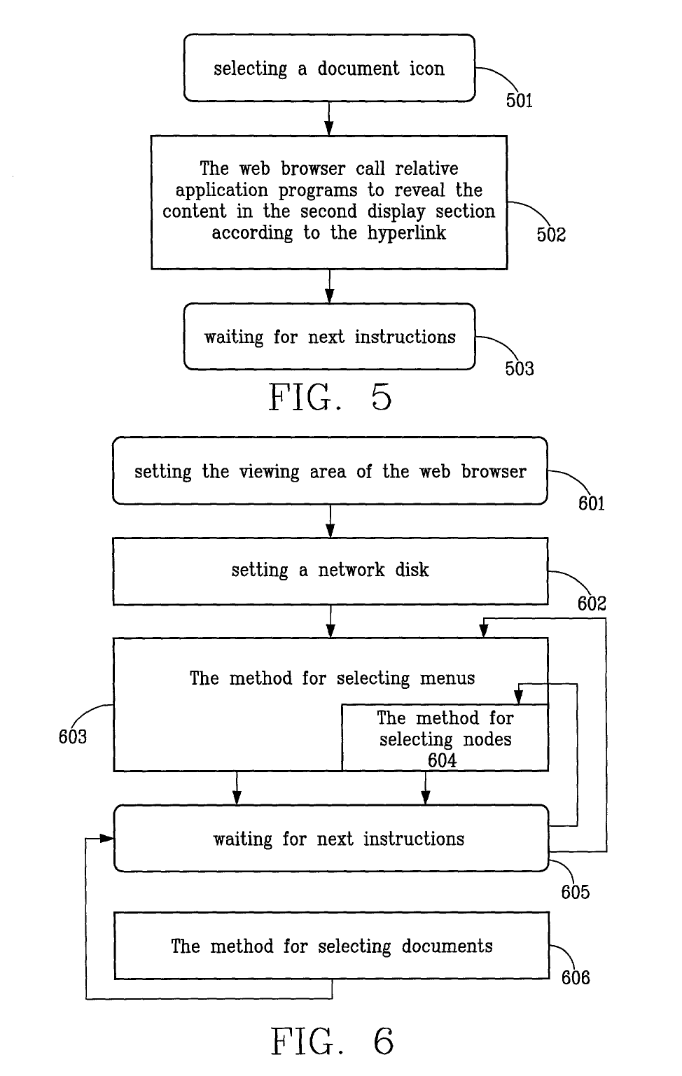

As shown in FIG. 5, the method for selecting documents is initiated after a reception of instructions in selecting some document by users. The document will be opened by a web browser since the path of it has been set to be a hyperlink address. The web browser is going to call relative application programs to reveal the content in the second display section according to the hyperlink.

After that, if a user selects a menu, a node, or a document, methods with corresponding functions will process individually to complete the instructions. As shown in FIG. 6, this diagram brings up the relationship among brief procedures and methods to illustrate this invention. The viewing area of the web browser is set first 601 and the root menu is set second 602. Then the method for selecting menus 603 inclusive of method for selecting nodes 604 is applied. The selection is waited 605. The method for selecting menus 603, for selecting nodes 604, or for selecting documents 606 is executed depending on the selection of users. Something has to be explained here that the usage of method names is based on the convenience instead of specific names although this invention requires executing some method (such as method for selecting menus, method for selecting nodes, and method for selecting documents) in the process. Those who are familiar with ordinary skills can appreciate the spirit of this invention, hence are not going to confine it because of this.

All processes of methods mentioned can be written into programs for computer operators by using programming languages such as HTML, VBScript, and JavaScript. FIG. 7(a), FIG. 7(b), FIG. 7(c), and FIG. 7(d) give a preferred example about the possible operation procedures when a user employs this invention. Above all, the program being able to browse documents is executed and an accessing disk (or root menu) is selected (or designated), as shown in FIG. 7(a). Then an opening menu is selected. In a preferred example FIG. 7(b), the tree structure of file menus of the billboard is generated in the first display section 701 after the billboard is selected. The icons of the menus and documents in the billboard menu are displayed in the second display section 702. In FIG. 7(c), the accounting billboard in the billboard menu is selected. In FIG. 7(d), one trail balance in this accounting billboard menu is selected. This trail balance is an Excel document with extended name xls, and the content of the trail balance Exchange Rate is revealed in the second display section 703. The utilizing web browser in this preferred example is IE. It is noted that the content is revealed in the second display section instantaneously, not like the traditional way that takes a lot of time to execute the Excel and then exhibit the content.

It is a great breakthrough this invention opens documents by utilizing web browser. Users merely have to upload the documents to a server and this method invention will generate links between webs automatically without the demand for the design by web devisers. On the other hand, opening documents in similar way of web page and calling application programs by the web browser automatically can increase the efficiency of usage of computer resources. Besides, enterprises can centralize the management of documents, share them, and avoid the documents are stored in the PC disorderly.

This invention provides a method for opening various documents to preview approximately simultaneously by a user and revealing them in a web browser. Its process is: A web browser, whose viewing area is divided into a first display section used to reveal tree structure of document menus and a second display section used to preview the content of documents, is executed. The menus or documents in the first display section are selected. Then the web browser will respond to the instructions of the user and reveal the content of the menus or documents by calling programs or application programs relative to the menus or documents. Wherein, the paths of the documents have already been set to become hyperlink addresses.

The preferred example of this invention is illustrated above, and those who are familiar with ordinary skills in this field will appreciate that some modifications can be taken without any divergence from the spirit of this invention. The protection range of this invention should obey the following claims as well as its equal domain.

What is claimed is:

1. A method for browsing a document by utilizing a web browser, comprising following steps:
dividing a viewing area of said web browser into a first display section and a second display section, wherein said first display section shows a tree diagram of the locations of file menus and individual documents, and said second display section shows the contents of a selected document;
designating an accessing disk, and if said accessing disk being a file server on a network, thereby setting said disk as a network disk;
reading plural submenus, plural document names, and location paths from said accessing disk;
setting said location paths of said plural document menus to a hyperlink addresses;
forming a tree structure of locations of the said plural submenus and the said plural documents; and
displaying said tree structure of the said plural submenus and document menu in said first display section, said location paths of the said plural documents being hyperlink address, when a user selecting a document in said first display section, said web browser revealing the contents of said document in said second display section according to an associating application program.

2. A method of claim 1, further comprising following steps:
after an accessing disk is designated, and if said accessing disk being a file server on said network, designating said accessing disk to act as a network disk;
setting the location paths of the said plural documents to become hyperlink addresses;
generating a tree structure for the revealing the selected disk or the plural submenus and documents contained in the menus;
wherein setting said location path comprises following steps:
receiving a instruction to select a disk or menu;
checking said disk or menu being open or not;
waiting for next instruction if said disk or menu being opened;
executing successive step including:
fetching plural submenus or names and paths of plural document belong to said disk or menu;
generating a tree structure, which contains nodes precious plural submenus or documents individually belong to the said disk or menu; and
checking said plural nodes, if said plural node being menu nodes, then closing said menu nodes, otherwise, if said plural node being document nodes, setting the paths of said documents of said document nodes to become a hyperlink address.

3. A method of claim 1, wherein said web browser includes IE (Internet Explorer) or Netscape Navigator.

4. A method of claim 1, wherein the formats of said document comprises xls (Excel document), mdb (Access document), doc (Word document), ppt (PowerPoint document), txt (text document), rtf (text document), wri (text document), pdf (E-book), htm (web page), html (web page), eml (E-mail), .url (website address), asp (web page), and ordinary picture document (such as jpg, gif, bmp, etc.).

5. A method for utilizing web browser to view documents in various format, comprising following steps:
setting menu paths of said documents to become a hyperlink address;
displaying the tree structure of the menu names of documents whose menu paths have been set to become hyperlink addresses in said first viewing area of said web browser; and
waiting for selecting a document to be examined, and said selected document calling corresponding application programs by said web browser, then the content of said selected document being displayed in said second viewing area of said web browser via said hyperlink.

6. A method of claim 5, wherein said web browser includes IE (Internet Explorer) or Netscape Navigator.

7. A method of claim 5, wherein the format of said document comprises xls (Excel document), mdb (Access document), doc (Word document), ppt (PowerPoint document), txt (text document), rtf (text document), wri (text document), pdf (E-book), htm (web page), html (web page), eml (E-mail), url (website address), asp (web page), and ordinary picture document (such as jpg, gif, bmp, etc.).

8. A method for opening various documents to synchronously preview and reveal documents in a web browser by a user, comprising following steps:
dividing a viewing area of a web browser into a first display section used to reveal tree structure of document menus and a second display section used to preview the content of said documents; and
selecting said menus or said documents in said first display section, said web browser being responsive to the instructions of said user and revealing said content of said menus or documents by calling associated programs or application programs of said menus or documents; wherein the paths of said documents being set to become a hyperlink address.

9. A method of claim 8, wherein said web browser includes IE (Internet Explorer) or Netscape Navigator.

10. A method of claim 9, wherein the format of said document comprises xls (Excel document), mdb (Access document), doc (Word document), ppt (PowerPoint document), txt (text document), rtf (text document), wri (text document), pdf (E-book), htm (web page), html (web page), eml (E-mail), url (website address), asp (web page), and ordinary picture document (such as jpg, gif, bmp, etc.).
